(19) United States
(12) Patent Application Publication
(10) Pub. No.: US 2026/0190028 A1
(43) Pub. Date: Jul. 2, 2026

(54) WAKE-UP SIGNAL FOR POSITIONING REFERENCE SIGNALS

(71) Applicant: QUALCOMM INCORPORATED, San Diego, CA (US)

(72) Inventors: Alexandros MANOLAKOS, Escondido, CA (US); Mukesh KUMAR, Hyderabad (IN); Srinivas YERRAMALLI, San Diego, CA (US)

(21) Appl. No.: 19/124,763

(22) PCT Filed: Oct. 13, 2023
(86) PCT No.: PCT/US2023/035147

§ 371 Date: Apr. 25, 2025

(30) Foreign Application Priority Data
Nov. 18, 2022 (GR) 20220100955

(51) Int. Cl. H04W 52/02; H04L 5/00

(52) U.S. Cl. CPC H04W 52/0235; H04L 5/0051

(57) ABSTRACT

Aspects presented herein may enable a network entity to configure a UE to process positioning signals (e.g., to receive PRS, to transmit SRS, etc.) in a subset of a DRX ON duration, where the UE may be scheduled for both PRS and SRS with the same WUS/PDCCH signalling. In one aspect, a UE obtains a configuration of at least one of a PRS reception or an SRS transmission associated with a WUS. The UE receives the WUS from a network entity, where the WUS is associated with a set of PDCCH MOs inside a DRX ON duration. The UE performs at least one of the PRS reception during a PRS reception window inside the DRX ON duration or the SRS transmission during an SRS transmission window inside the DRX ON duration based on the reception of the WUS.

### CROSS-REFERENCE TO RELATED APPLICATION

This application claims the benefit of Greece Patent Application Serial No. 20220100955, entitled “WAKE-UP SIGNAL FOR POSITIONING REFERENCE SIGNALS” and filed on Nov. 18, 2022, which is expressly incorporated by reference herein in its entirety.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus obtains a configuration of at least one of a positioning reference signal (PRS) reception or a sounding reference signal (SRS) transmission associated with a wake-up signal (WUS). The apparatus receives the WUS from a network entity, where the WUS is associated with a set of physical downlink control channel (PDCCH) monitoring occasions (MOs) inside a discontinuous reception (DRX) ON duration. The apparatus performs at least one of the PRS reception during a PRS reception window inside the DRX ON duration or the SRS transmission during an SRS transmission window inside the DRX ON duration based on the reception of the WUS.

In an aspect of the disclosure, a method, a computer-readable medium, and an apparatus are provided. The apparatus transmits, for a UE, a configuration of at least one of a PRS reception or an SRS transmission associated with a WUS. The apparatus transmits the WUS to the UE, where the WUS is associated with a set of PDCCH MOs inside a DRX ON duration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example downlink (DL) positioning reference signal (PRS) resource prioritization in accordance with various aspects of the present disclosure.

FIG. 6 is a diagram illustrating an example of different radio resource control (RRC) states in accordance with various aspects of the present disclosure.

FIG. 7 is a diagram illustrating an example of a discontinuous reception (DRX) cycle that may be configured by a base station for a UE in accordance with various aspects of the present disclosure.

FIG. 8 is a diagram illustrating an example of a wake-up signal (WUS) monitoring occasion at a UE in accordance with various aspects of the present disclosure.

FIG. 9 is a diagram illustrating an example of a cross-slot scheduling adaption in accordance with various aspects of the present disclosure.

FIG. 10 is a diagram illustrating an example of configuring a UE to monitor for a WUS outside a DRX active time in accordance with various aspects of the present disclosure.

FIG. 11 is a diagram illustrating an example configuration for a WUS based on a downlink control information (DCI) format 2_6 in accordance with various aspects of the present disclosure.

FIG. 12 is a diagram illustrating an example composition and functionality of a DCI format 2_6 in accordance with various aspects of the present disclosure.

FIG. 13 is a diagram illustrating an example of cross-carrier scheduling in accordance with various aspects of the present disclosure.

FIG. 14A is a diagram illustrating an example of a UE monitoring all PDCCH occasions after receiving a WUS in accordance with various aspects of the present disclosure.

FIG. 14B is a diagram illustrating an example of a UE skips monitoring all PDCCH occasions after not receiving a WUS in accordance with various aspects of the present disclosure.

FIG. 15 is a communication flow illustrating an example of scheduling a UE to receive PRSs and/or to transmit sounding reference signals (SR Ss) during a subset (e.g., a portion) of a DRX ON duration after detecting a WUS in accordance with various aspects of the present disclosure.

FIG. 16A is a diagram illustrating an example of a separate WUS based scheduling for PRS (reception) and SRS (transmission) in accordance with various aspects of the present disclosure.

FIG. 16B is a diagram illustrating an example of a same WUS based scheduling for PRS (reception) and SRS (transmission) in accordance with various aspects of the present disclosure.

FIG. 16C is a diagram illustrating an example of a same WUS based scheduling for PRS (reception) and SRS (transmission) on different DRX ON durations (or cycles) in accordance with various aspects of the present disclosure.

FIG. 16D is a diagram illustrating an example of a WUS based scheduling for sidelink (SL) transmission and/or reception in accordance with various aspects of the present disclosure.

FIG. 17 is a diagram illustrating an example of a WUS based cross positioning frequency layer (PFL) scheduling in accordance with various aspects of the present disclosure.

FIG. 18 is a flowchart of a method of wireless communication.

FIG. 19 is a diagram illustrating an example of a hardware implementation for an example apparatus and/or network entity.

FIG. 20 is a flowchart of a method of wireless communication.

FIG. 21 is a diagram illustrating an example of a hardware implementation for an example apparatus and/or network entity.

### DETAILED DESCRIPTION

Aspects presented herein may improve the positioning of a UE when the UE is under an idle/inactive mode. Aspects presented herein may enable a network entity (e.g., a base station, a location server, an LMF, etc.) to configure a UE to process positioning signals (e.g., to receive PRS, to transmit SRS, etc.) in a subset of a DRX ON duration, where the UE may be scheduled for both PRS and SRS with the same WUS/PDCCH signalling. Aspects presented herein may also enable the network entity to provide cross PFL scheduling of the PRS and SRS through a WUS of a serving cell, thereby improving the efficiency of the PRS/SRS scheduling in a UE positioning session.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TR P), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IA B) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

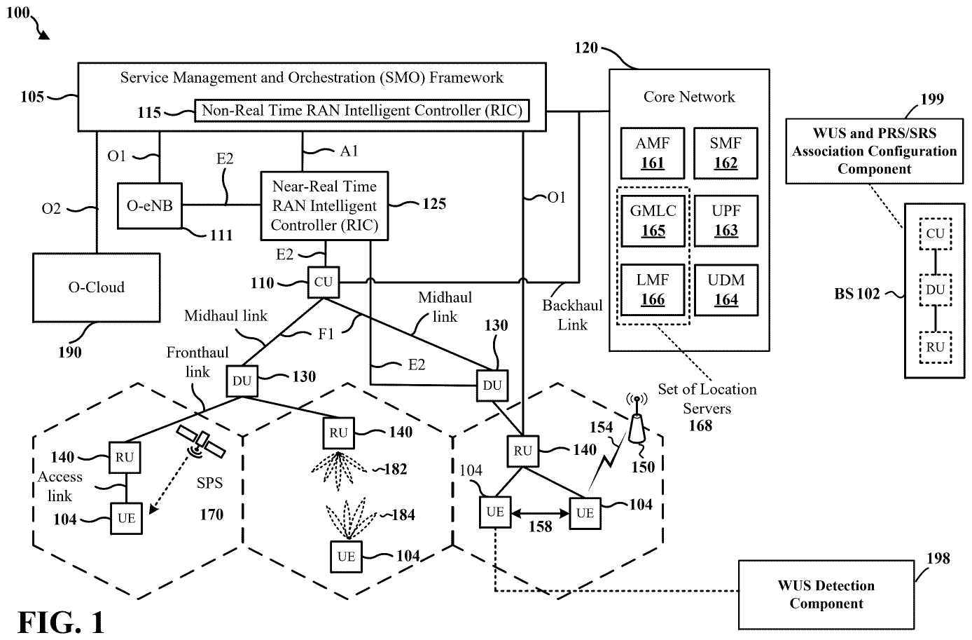

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GH z-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SM F 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to obtain a configuration of at least one of a PRS reception or an SRS transmission associated with a WUS; receive the WUS from a network entity, where the WUS is associated with a set of PDCCH MOs inside a DRX ON duration; and performs at least one of the PRS reception during a PRS reception window inside the DRX ON duration or the SRS transmission during an SRS transmission window inside the DRX ON duration based on the reception of the WUS (e.g., via the WUS detection component 198).

In certain aspects, the base station 102 may be configured to transmit, for a UE, a configuration of at least one of a PRS reception or an SRS transmission associated with a WUS; and transmit the WUS to the UE, where the WUS is associated with a set of PDCCH MOs inside a DRX ON duration (e.g., via the WUS and PRS/SRS association configuration component 199).

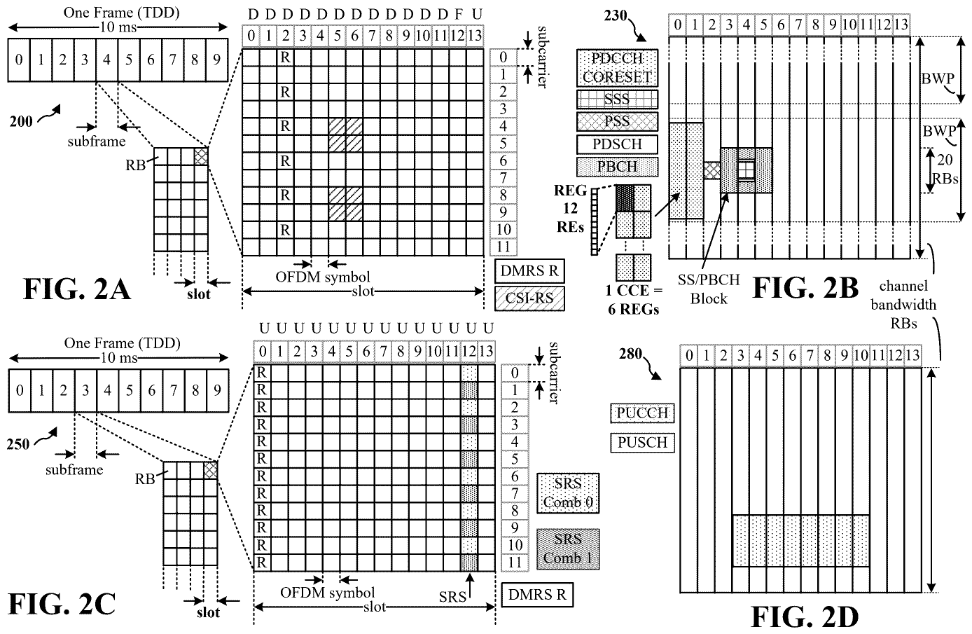

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 KHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PB CH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

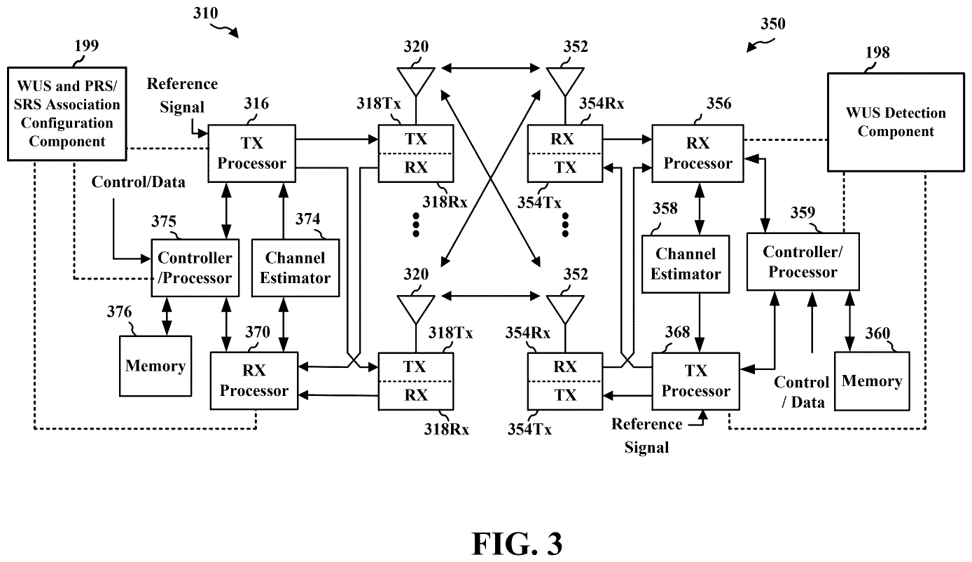

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PD Us, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the WUS detection component 198 of FIG. 1.

At least one of the TX processor 316, the RX processor 370, and the controller/processor 375 may be configured to perform aspects in connection with the WUS and PRS/SRS association configuration component 199 of FIG. 1.

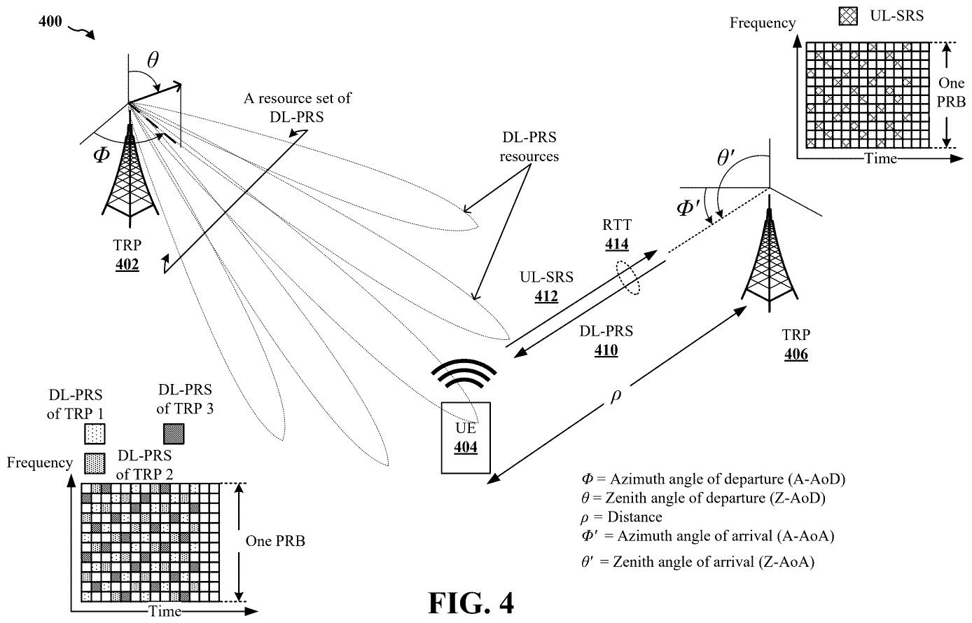

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

A positioning frequency layer (PFL) (or a “frequency layer” in some examples) may refer to a collection of one or more PRS resource sets across one or more TRPs that have the same values for certain parameters. Specifically, the collection of PRS resource sets may have the same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN−ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

In some scenarios, a UE may receive a plurality of PRS resources from multiple TRPs via one or more PFLs, where the UE may not have capabilities to process all of the plurality of PRS resources. As such, the UE may apply a predefined prioritization rule to prioritize measurements of PRS resources. Based on the predefined prioritization rule, the UE may measure a subset of the plurality of PRS resources, and the UE may skip measuring another subset of the plurality of PRS resources.

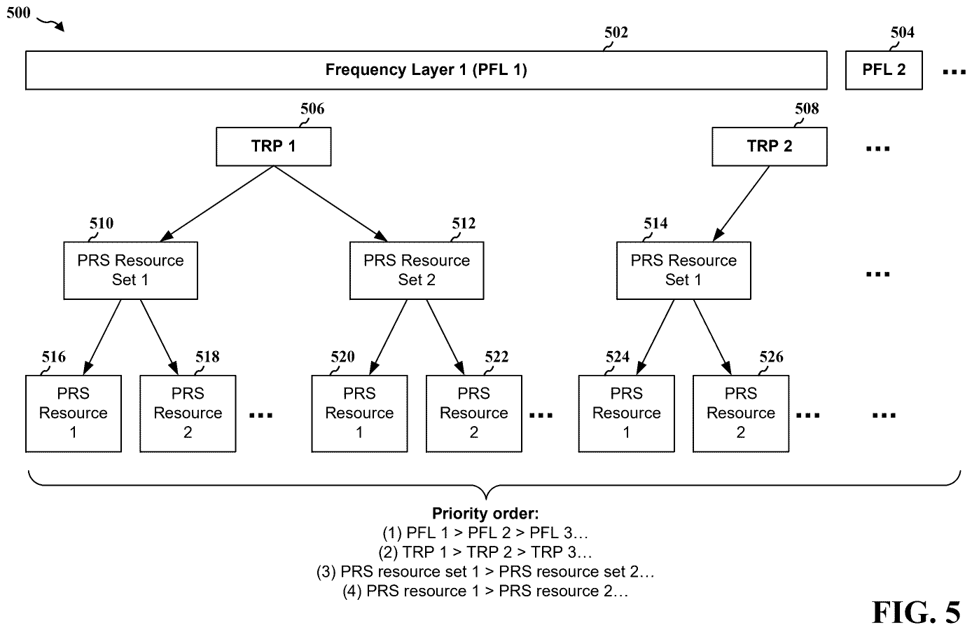

FIG. 5 is a diagram 500 illustrating an example DL PRS resource prioritization in accordance with various aspects of the present disclosure. A UE may be configured with a number of PRS resources in an assistance data of a positioning session, where the number of PRSs resources to be process by the UE may be beyond the processing capability of the UE. In one example, the UE may assume the DL PRS resources in the assistance data are sorted in a decreasing order of measurement priority. For example, if the UE is configured to receive or measure the DL PRS resources via multiple frequency layers (e.g., PFLs), where each PFL may include PRS resources transmitted from multiple TRPs in, the UE may measure the DL PRS resources based on the priority associated with the multiple frequency layers (e.g., from a first frequency layer to a last frequency layer), based on the priority associated with the TRPs in each PFL (e.g., from a first TRP to a last TRP in a PFL), based on the priority associated with the RPS resource sets associated with each TRP (e.g., from a first PRS resource set to a last PRS resource set in a TRP), and based on the priority associated with the RPS resources within each PRS resource set (e.g., from a first PRS resource to a last PRS resource in a resource set), etc.

For example, as shown by the diagram 500, the UE may be configured to receive DL PRSs from a first frequency layer 502 (PFL 1) and a second frequency layer 504 (PFL 2). The first frequency layer 502 may include DL PRSs transmitted from a first TRP 506 and a second TRP 508, where the first TRP 506 may transmit PRSs using a first PRS resource 516 and a second PRS resource 518 in a first PRS resource set 510, and using a first PRS resource 520 and a second PRS resource 522 in a second PRS resource set 512, and the second TRP 508 may transmit PRSs using a first PRS resource 524 and a second PR S resource 526 in a first PRS resource set 514. Similarly, the UE may also receive DL PRSs from the second frequency layer 504 via multiple TRPs, PRS resource sets, and/or PRS resources.

In one example, if the UE does not have the capability to process all the configured PRS resources, the UE may be configured to receive or measure the PRSs received from the first frequency layer 502 first before processing PRSs in the second frequency layer 504. Similarly, if there are also a third frequency layer (PFL 3) and a fourth frequency layer (PFL 4), the UE may be configured to receive or measure the PRSs received from the first frequency layer 502 first, then the PRSs received from the second frequency layer 504, then the PRSs received from the third frequency layer, and then the PRSs received from the fourth frequency layer (e.g., PRSs are processed/measured based on PFL 1>PFL 2>PFL 3>PFL 4). If the UE does not have the capability to process/measure PR Ss in a frequency layer, the UE may skip measuring the PR Ss in that frequency layer. For example, if the UE is configured to receive the PRSs via the first frequency layer 502 and the second frequency layer 504 but the UE is just able to process/measure PRSs in the first frequency layer 502, the UE may skip PRS measurements for the second frequency layer 504.

Similarly, within a frequency layer, if the UE does not have the capability to process all the PR Ss in the frequency layer, the UE may prioritize its PRS measurements based on the priorities associated with the TRPs. For example, the UE may be configured to receive or measure the PRSs received from the first TRP 506 before processing PRSs from the second TRP 508. Similarly, if there are also a third TRP (TRP 3) and a fourth TRP (TRP 4), the UE may be configured to receive or measure the PRSs received from the first TRP 506, then receive or measure the PR Ss from the second TRP 508, then receive or measure the PRSs from the third TRP, and then receive or measure the PRSs from the fourth TRP (e.g., PRSs are processed/measured based on TRP 1>TRP 2>TRP 3>TRP 4 with a frequency layer). If the UE does not have the capability to process/measure PRSs from a TRP, the UE may skip measuring the PRSs in that TRP. For example, if the UE is configured to receive the PRSs via the first TRP 506 and the second TRP 508 via the first frequency layer 502 but the UE is just able to process/measure PRSs in the first TRP 506, the UE may skip PRS measurements for the second TRP 508.

Furthermore, within a TRP, if the UE does not have the capability to process all the PRSs in that TRP, the UE may prioritize its PRS measurements based on the priorities associated with the PRS resource sets. For example, the UE may be configured to receive or measure the PR Ss received from the first PRS resource set 510 first before processing PR Ss from the second PRS resource set 512. Similarly, if there are also a third PRS resource set (PRS resource set 3) and a fourth PRS resource set (PRS resource set 4), the UE may be configured to receive or measure the PRSs received from the first PRS resource set 510 first, then the PR Ss received from the second PRS resource set 512, then the PR Ss received from the third PRS resource set, and then the PRSs received from the fourth PRS resource set (e.g., PR Ss are processed/measured based on PRS resource set 1>PRS resource set 2>PRS resource set 3>PRS resource set 4 with a TRP). If the UE does not have the capability to process/measure PR Ss in a PRS resource set, the UE may skip measuring the PRSs in that PRS resource set. For example, if the UE is configured to receive the PRSs via the first PRS resource set 510 and the second PRS resource set 512 from the first TRP 506 but the UE is just able to process/measure PR Ss in the first PRS resource set 510, the UE may skip PRS measurements for the second PRS resource set 512.

Lastly, within a PRS resource set, if the UE does not have the capability to process all the PRSs in that PRS resource set, the UE may prioritize its PRS measurements based on the priorities associated with the PRS resources. For example, the UE may be configured to receive or measure the PRSs received from the first PRS resource 516 first before processing PR Ss from the second PRS resource 518. Similarly, if there are also a third PRS resource (PRS resource 3) and a fourth PRS resource (PRS resource 4), the UE may be configured to receive or measure the PR Ss received from the first PRS resource 516 first, then the PR Ss received from the second PRS resource 518, then the PR Ss received from the third PRS resource, and then the PRSs received from the fourth PRS resource (e.g., PRSs are processed/measured based on PRS resource 1>PRS resource 2>PRS resource 3>PRS resource 4 with a PRS resource set). If the UE does not have the capability to process/measure PRSs in a PRS resource, the UE may skip measuring the PR Ss in that PRS resource. For example, if the UE is configured to receive the PR Ss via the first PRS resource 516 and the second PRS resource 518 of the first PRS resource set 510 but the UE is just able to process/measure PRSs in the first PRS resource 516, the UE may skip PRS measurements for the second PRS resource 518.

As such, if a UE is configured with multiple PRS resources via multiple frequency layers, multiple TRPs, multiple PRS resource sets, and/or multiple PRS resources, the UE may sort the frequency layers (e.g., may be up to four frequency layers) according to a priority, sort the TRPs per frequency layer (e.g., may be up to sixty four (64) TRPs per frequency layer) also according to a priority, sort the PRS resource sets per TRP (e.g., may be up to two resource sets per TRP) according to a priority, and/or sort the PRS resource per PRS resource set (e.g., may be up to sixty four (64) PRS resources per PRS resource set). In other words, within a positioning frequency layer, the DL PRS resources may be sorted in the decreasing order of priority for measurement to be performed by the UE, with the reference indicated by nr-DL-PRS-ReferenceInfo being the highest priority for measurement, and the following priority is assumed: (1) up to 64 dl-PRS-IDs of the frequency layer are sorted according to priority; and (2) up to 2 DL PRS resource sets per dl-PRS-ID of the frequency layer are sorted according to priority.

To minimize latency and/or to reduce signaling load, if there is no activity from a UE for a defined duration, the UE may be configured to suspend its communication session (e.g., with a network entity such as a base station) by transitioning to a radio resource control (RRC) inactive state. For example, after a random-access procedure, a UE may be in an RRC connected state. The RRC protocol may be used on an air interface between a UE and a base station. The major functions of the RRC protocol may include connection establishment and release functions, broadcast of system information, radio bearer establishment, reconfiguration, and release, RRC connection mobility procedures, paging notification and release, and/or outer loop power control, etc. In some examples, such as in LTE, a UE may be in one of two RRC states (e.g., a connected state or an idle state). In other examples, such as in NR, a UE may be in one of three RRC states (e.g., a connected state, an idle state, or an inactive state). The different RRC states may have different radio resources associated with each state that a UE may use when the UE is in a given state. In some examples, the RRC states may also be referred to as RRC modes.

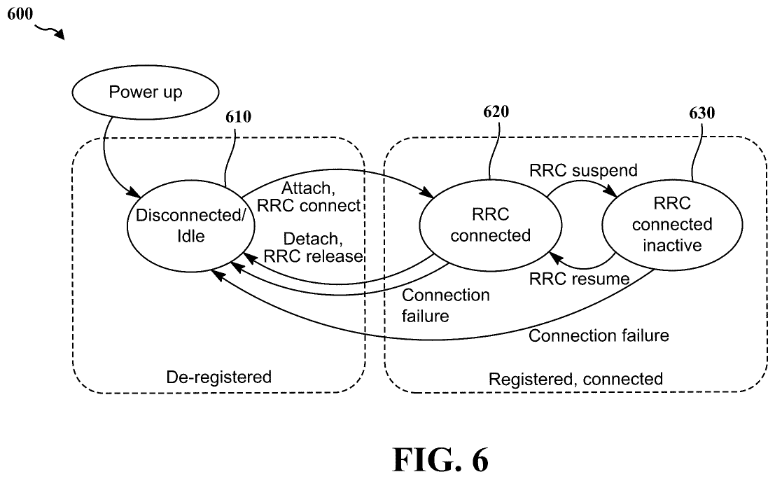

FIG. 6 is a diagram 600 illustrating an example of different RRC states in accordance with various aspects of the present disclosure. When a UE is powered up, the UE may initially be in an RRC disconnected/idle state 610. After a random access procedure, the UE may transition (or move) to an RRC connected state 620. If there is no activity at the UE for a defined duration, the UE may suspend its communication session (e.g., with a base station) by transitioning to an RRC inactive state 630. The UE may resume its communication session by performing a random access procedure to transition back to the RRC connected state 620. Thus, the UE may be specified to perform a random access procedure to transition to the RRC connected state 620, regardless of whether the UE is in the RRC idle state 610 (or simply an idle state or an idle mode) or the RRC inactive state 630 (or simply an inactive state or an inactive mode). As such, the RRC inactive state 630 may be a state between the RRC connected state 620 and the RRC disconnected/idle state 610 where the UE may stay in an inactive state without completely releasing the RRC when there is no traffic and quickly switch back to connected states when necessary.

In some examples, the RRC idle state 610 may be used for public land mobile network (PLMN) selection, broadcast of system information, cell re-selection mobility, paging for mobile terminated data (initiated and managed by the 5GC), and/or discontinuous reception (DRX) for core network paging (configured by non-access stratum (NAS)), etc. In other examples, the RRC connected state 620 may be used for 5GC and new RAN connection establishment (both control and user planes), UE context storage at the new RAN and the UE, new RAN knowledge of the cell to which the UE belongs, transfer of unicast data to/from the UE, and/or network controlled mobility, etc. In other examples, the RRC inactive state 630 may be used for the PLM N selection, broadcast of system information, cell re-selection for mobility, paging (initiated by the new RAN), RAN-based notification area (RNA) management (by the new RAN), DRX for RAN paging (configured by the new RAN), 5GC and new RAN connection establishment for the UE (both control and user planes), storage of the UE context in the new RAN and the UE, and/or new RAN knowledge of the RNA to which the UE belongs, etc.

In some scenarios, during a UE positioning session, a UE (e.g., the UE 404) may also transition into the RRC inactive state to conserve radio and/or power resources while continuing to participate in the UE positioning session. For example, during a UE-assisted positioning session, a UE may transition into an RRC inactive state while continuing to measure DL PRS transmitted from a base station and report the DL PRS measurements to the base station or a location server. In one example, the UE may report the DL PRS measurements based on small data transmission (SDT) (or UL SDT). The SDT may refer to a transmission for a short data burst in a connectionless state where a UE is not specified to establish connections when small amounts of data or data below a size threshold is to be sent by the UE. In other words, SDT may enable a UE in an RRC inactive state to transmit infrequent and small data without specifying an RRC state transition.

For example, in some wireless communication networks, uplink (UL) data generated in an RRC idle state of a UE may be transmitted by the UE after the UE transitions to an RRC connected state. The UE may transition from the RRC idle state to the RRC connected state transmitting an RRC resume request message to the serving base station. After transmission of the UL data, a UE in the RRC connected state may be specified to receive an RRC release message from a base station for transitioning back to the RRC idle state. This UL transmission mechanism may not be suitable for UL data below certain size(s) (e.g., which may be referred to as small data or SDT) as the overheads of the overall procedure are inefficient to transmit small amount of data (e.g., the size of the overheads may be larger than the data and/or the time it takes to transition the UE to RRC connected state may be longer than the actual data transmission, etc.). To improve the resource utilization, some wireless communication networks may include mechanisms for transmitting SDT without specifying the UE to transition to an RRC connected stated. For example, a wireless communication network may support early data transmission (EDT) and transmission using pre-configured uplink resource (PUR). The EDT may enable a UE device to receive UL grant for SDT in an RRC idle/inactive state via a random access procedure for the EDT. The UE in the RRC idle/inactive state may transmit UL small data using the uplink grant. The transmission using PUR allows SDT from an RRC idle/inactive state using PUR without performing a random access procedure. For purposes of the present disclosure, an UL SDT message may refer to a message with a size that qualifies as an SDT (e.g., the size is below certain threshold) and may be transmitted by a UE based on the EDT mechanism.

Similarly, during a network-based positioning session, a UE may also be configured to transmit UL SRS while in an RRC inactive state. For example, an assistance data with SRS configuration may be provided to the UE while the UE is in the RRC connected state, and the UE may continue to transmit SRS based on the SRS configuration after transition to the RRC inactive state. In other words, the assistance data is provided when the UE is in RRC connected state and carries over to the RRC inactive state.

As described in connection with FIG. 6, when a UE enters into an RRC idle/inactive state/mode, the UE may reduce power consumption by performing a DRX operation in which the UE monitors for communication or transmits communication during a DRX ON duration and does not monitor for communication or transmit communication during a DRX OFF duration. For example, the UE may monitor for transmission (e.g., from a network entity such as a base station) discontinuously using a sleep and wake cycle. The DRX OFF duration may correspond to a time during which the UE operates in a lower power mode, a sleep mode, etc. During the DRX OFF duration, the UE may shut down, turn off, or not use a radio frequency (RF) function. The DRX pattern may include one or more timers or values, such as an DRX ON duration timer or a value that indicates the starting point of the DRX ON duration and/or the DRX OFF duration, etc. The DRX ON duration timer may indicate a period of time, e.g., in consecutive symbols, slots, subframes, or TTIs, in which the UE wakes up from the DRX OFF duration and monitors for control signaling. A DRX cycle may include a periodic repetition of the DRX ON duration and the DRX OFF duration. By having periods during which the UE does not monitor for or transmit communication, the UE may save power or extend battery life for the UE. For example, DRX may provide power savings, e.g., at a physical layer or a medium access control (MAC) layer.

A base station may configure a UE with a DRX configuration. For example, the base station may configure DRX parameters for the UE that indicate the DRX cycle, the DRX ON duration, etc. Additionally, the base station may schedule communications for the UE based on the UE's DRX configuration as the base station is aware of the DRX configuration provided to the UE.

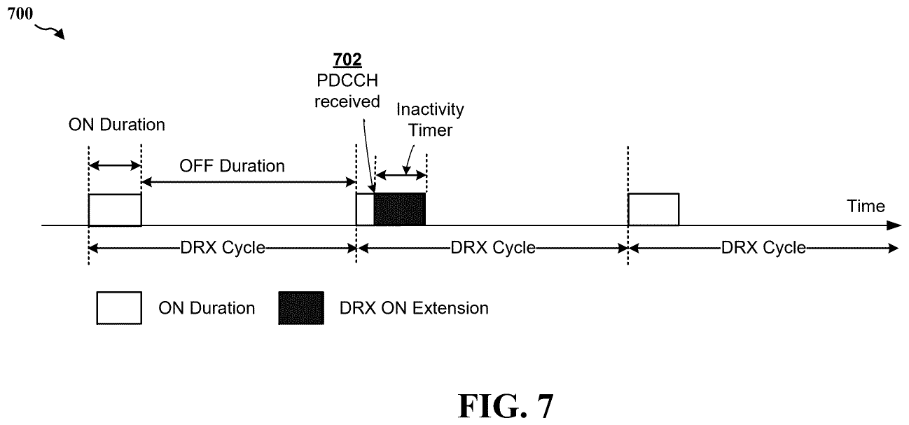

FIG. 7 is a diagram 700 illustrating an example of a DRX cycle that may be configured by a base station for a UE in accordance with various aspects of the present disclosure. A UE may monitor for a PDCCH from a base station during a DRX ON duration and may skip monitoring for a PDCCH during a DRX OFF duration. If the UE receives a PDCCH during the on duration, such as illustrated at 702, the UE may stay awake for an extended period of time based on an inactivity timer that starts upon reception of the PDCCH. If the UE does not receive downlink communication from the base station during the duration of the inactivity timer, the UE may stop monitoring, e.g., enter a sleep mode or lower power mode, for the remaining DRX OFF duration.

In some network configurations, a network entity (e.g., a base station) may transmit a paging signal, which may also be referred to as a wake-up signal (WUS), to a UE in an idle/inactive state to wake up the UE from the idle/inactive state, such that the UE may prepare receiving/transmitting data. In some examples, as a WUS may be received via a PDCCH, the WUS may also be referred to as a PDCCH-WUS.

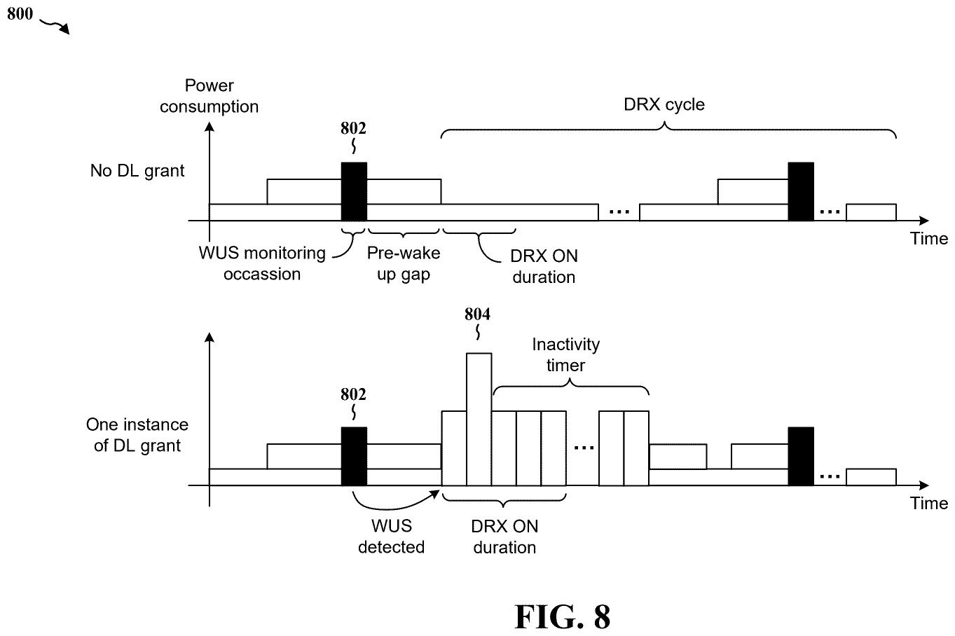

FIG. 8 is a diagram 800 illustrating an example of a WUS monitoring occasion at a UE in accordance with various aspects of the present disclosure. As shown at 802, a WUS may be a PDCCH (e.g., a special/specific type of PDCCH) sent by a network entity (e.g., a base station) to a UE before a DRX ON duration of the UE, where the WUS may indicate whether the UE may skip monitoring the next DRX ON duration. In other words, a UE may be configured with a two-stage wake-up, where the first stage is for PDCCH-WUS detection and the second stage is for monitoring scheduling and reception of new data, such as shown at 804. This two-stage wake-up configuration may facilitate a low power implementation for PDCCH-WUS detection, because during the first stage of wake-up, one or more of following optimizations may become feasible: (1) configuring a minimal set of hardware that is to be brought online for PDCCH processing; (2) configuring the operating point in terms of the voltage levels and clock frequencies of the hardware; (3) providing a more relaxed PDCCH processing timeline due to the WUS offset (e.g., offline processing); and/or potentially reducing the reception (Rx) bandwidth, a number of candidates/aggregation levels for PDCCH-WUS, etc.

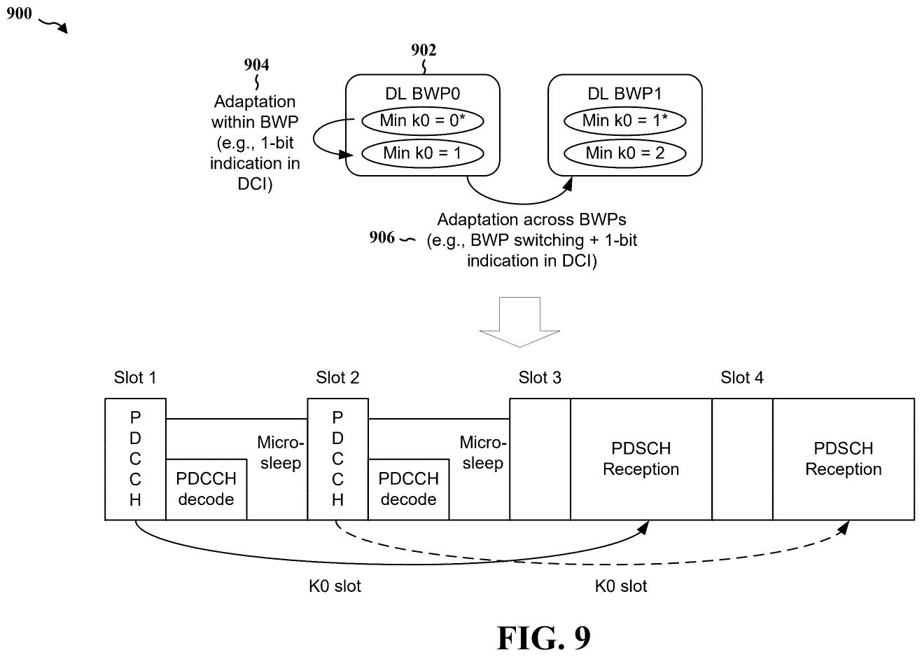

FIG. 9 is a diagram 900 illustrating an example of a cross-slot scheduling adaption in accordance with various aspects of the present disclosure. In some network configurations, a cross-slot scheduling mechanism may be adopted/implemented to reduce UE buffering. For example, a UE may start buffering an entire bandwidth of an active downlink BWP for potential data scheduling by a base station at the start of a control channel monitoring (e.g., a search space occasion). This is because data may be scheduled by DCI via control channel monitoring as early as the starting of the monitoring. When the UE is not fully active (e.g., in an idle state/mode), there may be no data scheduled in the search space occasion. This may lead to unnecessary data buffering as there is no data scheduled for the UE. To avoid such buffering, cross-slot scheduling may be adopted to ensure a minimum gap between a control channel and corresponding data. Based on the minimum gap between the control channel and the corresponding data, the UE may not be specified to buffer data during the minimum gap. The UE may also not be specified to buffer data after the minimum gap when the UE has not received any scheduling DCI on the search space occasion.

For example, as shown at 902, a cross-slot scheduling may include explicit minimum scheduling offset (e.g., minimum value for k0 and/or k2) parameters, which may be RRC-configured per BWP for a UE. A base station may also use one-bit in DCI to indicate to a UE to change between up to two (2) preconfigured values. As shown at 904, the cross-slot scheduling may support adaptation within a single active BWP, which may provide faster switching latency, e.g., an application delay on the order of the current minimum k0 (down to 1 or 2 slots). As shown at 906, the cross-slot scheduling may support adaptation cross BWPs, which may provide a better support for minimum scheduling offset and BWP switching. For example, a minimum scheduling offset of a currently active BWP may be jointly considered with BWP switch delay for k0/k2 restriction for cross-BWP scheduling. In some examples, the time domain resource allocation (TDRA) of all non-active BWPs may be considered in case of a BWP switching.

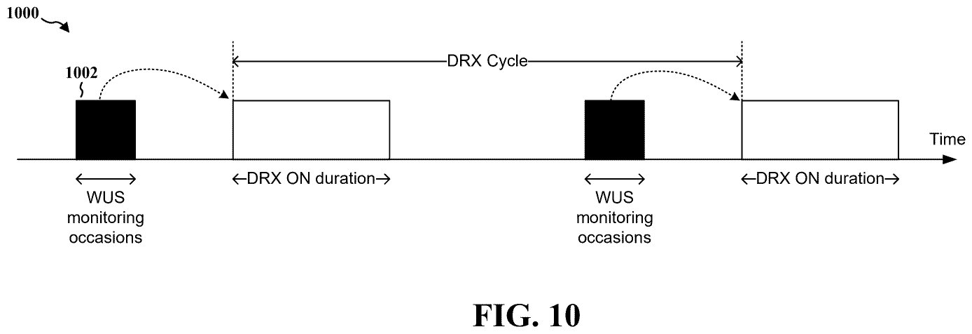

FIG. 10 is a diagram 1000 illustrating an example of configuring a UE to monitor for a WUS outside a DRX active time in accordance with various aspects of the present disclosure. As shown at 1002, a UE configured with a DRX mode operation (e.g., as described in connection with FIGS. 7 and 8) may also be configured to monitor a WUS outside a DRX active time. For example, a set of WUS monitoring occasions may be associated with each DRX cycle. A WUS may indicate whether the UE's MAC entity is to start a DRX ON duration timer (e.g., drx-onDurationTimer) for a next DRX cycle. In addition, the WUS may not impact other timers, such as the BWP inactivity timer (e.g., bwp-inactivityTimer), the data inactivity timer (e.g., dataInactivityTimer), and/or the SCell deactivation timer (e.g., sCellDeactivationTimer), etc.

In some examples, a WUS may be a PDCCH defined by a DCI format 2_6 with cyclic redundancy checks (CRC) scrambled by a power saving-radio network temporary identifier (PS-RNTI). A WUS may be shared by a group of UEs and may be monitored in common search space sets. In other examples, a WUS may be configured just on a PCell or a PSCell, and the WUS may indicate a dormancy behavior for (up to 5) SCell groups.

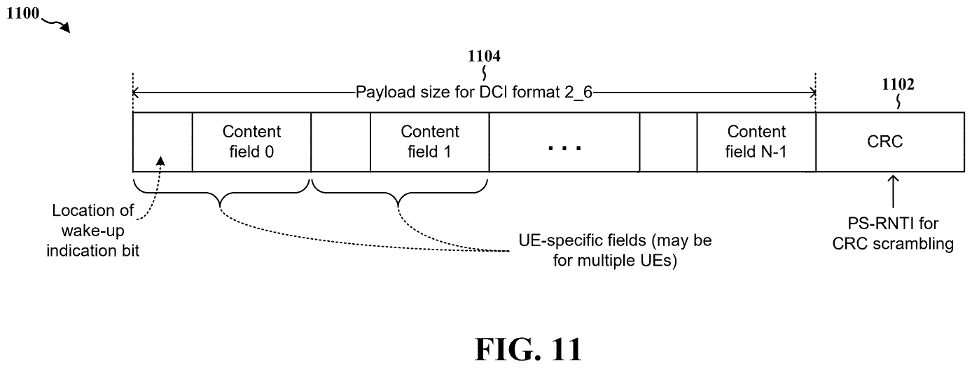

FIG. 11 is a diagram 1100 illustrating an example configuration for a WUS based on a DCI format 2_6 in accordance with various aspects of the present disclosure. As shown at 1102, a WUS based on a DCI format 2_6 may include a PS-RNTI for scrambling CRC of the DCI format 2_6, where a UE may be configured with a Type3-PDCCH common search space (CSS) set(s) for monitoring the DCI format 2_6 with the PS-RNTI. IN some examples, more than one search space set may be configured for DCI format 2_6, and associated control resource sets (CORESETs) with the search space sets may have different TCI states (e.g., for WUS beam sweeping in frequency range 2 (FR2)).

As shown at 1104, the payload of a WUS may include multiple UE-specific fields (e.g., for multiple UEs), and each UE-specific field may include a wake-up indication bit for indicating the position of the corresponding UE-specific field. For example, the DCI format 2_6 (or the PDCCH-WUS) may be shared by a group of UEs, where each UE in the group may be assigned with a UE-specific field in the DCI format 2_6. In some examples, SCell groups (e.g., up to 5) for dormancy behavior indication may be configured outside of a DRX active time, and SCell groups for dormancy behavior indication during the DRX active time may be configured separately (e.g., by scheduling DCI). In addition, a time offset parameter (e.g., ps_Offset) may be used for indicating a time that a UE starts locating monitoring occasions for DCI format 2_6 prior to a slot where a DRX cycle start, where the time offset may be 0.125 milliseconds (ms), 0.25 ms, 0.375 ms, . . . , 15 ms, etc. (e.g., ps_Offset∈{0.125 ms, 0.25 ms, 0.375 ms, . . . , 15 ms}).

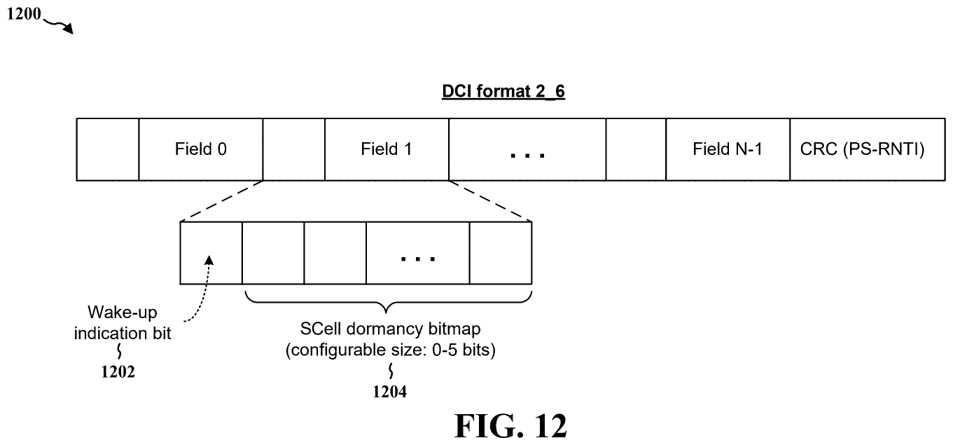

FIG. 12 is a diagram 1200 illustrating an example composition and functionality of a DCI format 2_6 in accordance with various aspects of the present disclosure. After a DCI format 2_6 is detected on a WUS monitor occasion (MO) by a UE, the UE may find an assigned field within the DCI. For example, as shown at 1202 and 1204, each UE-specific field may include a wake-up indication bit and a bitmap for SCell dormancy indication (e.g., with a configurable size between 0-5 bits), which may be used for indicating different UE behaviors. Table 2 below provides an example of different UE behaviors for different wake-up indications and different bitmaps for SCell dormancy indication.

TABLE 2
Example UE Behaviors

| | Indicated UE behavior | |
|---|---|---|
| | Bit ‘0’ | Bit ‘1’ |
| Wake-up | Do not start drx- | Start drx-onDurationTimer |
| indication bit | onDurationTimer for | for the next DRX cycle |
| | the next DRX cycle | |
| Bitmap for | For each activated SCell | For each activate SCell |
| SCell | in the corresponding | in the corresponding |
| dormancy | SCell group: | SCell group: |
| indication | If the current active BWP | If the current active |
| | is a non-dormant BWP, it | BWP is a non-dormant |
| | switches to the dormant- | BWP, it continues with |
| | BWP | the same BWP |
| | If the current active | If the current active |
| | BWP is the dormant BWP, | BWP is the dormant BWP, |
| | it continues with the | it switches to a specific |
| | dormant BWP | non-dormant BWP |
| | | configured by RRC |

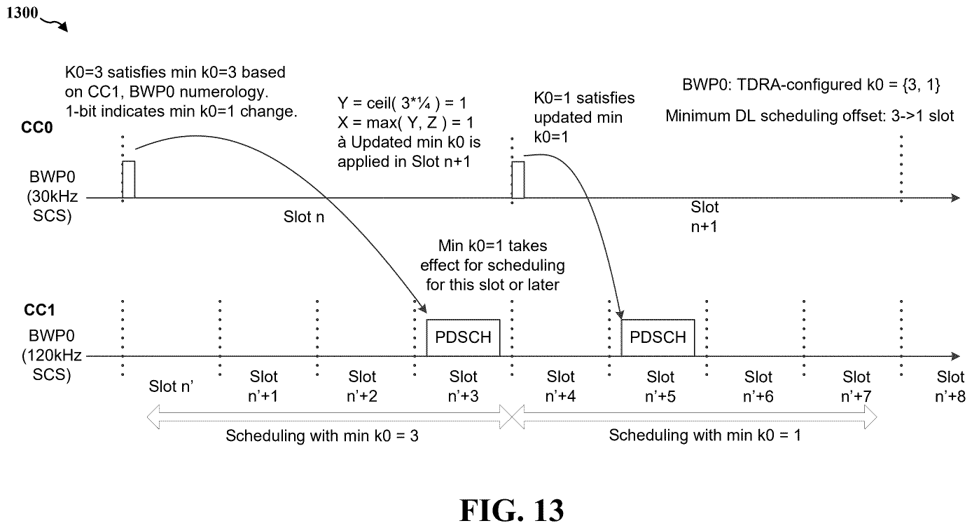

FIG. 13 is a diagram 1300 illustrating an example of cross-carrier scheduling in accordance with various aspects of the present disclosure. In some scenarios, scheduling grants and scheduling assignments may be transmitted on either the same cell as the corresponding data, known as self-scheduling, or on a different cell than the corresponding data, known as cross-carrier scheduling, such as shown by the diagram 1300. In one example, for a PDCCH monitoring based on a cross-carrier scheduling, an application delay of the cross-slot scheduling adaptation, denoted by X slot(s) for the scheduling cell, may be determined based on X=max(Y, Z), where Z may be determined by the SCS of the active DL BWP of the scheduling cell and takes value of 1/1/2/2 slot(s) for DL SCS of 15/30/60/120 KHz, respectively, and Y may be determined as one of the following alternatives: ceiling(minK_{0,scheduled}*2\hat{ }μ_{scheduling}/2\hat{ }_{scheduled}), where minK_{0,scheduled} is the minimum applicable K0 value of the active DL BWP of the scheduled cell prior to the change indication for the scheduled cell, μ_{scheduling} and μ_{scheduled} are the SCS indices for the scheduling cell and the scheduled cell, respectively. Such mechanism may also be used for cross PFL/PRS/SRS scheduling associated with UE positioning (discussed below).

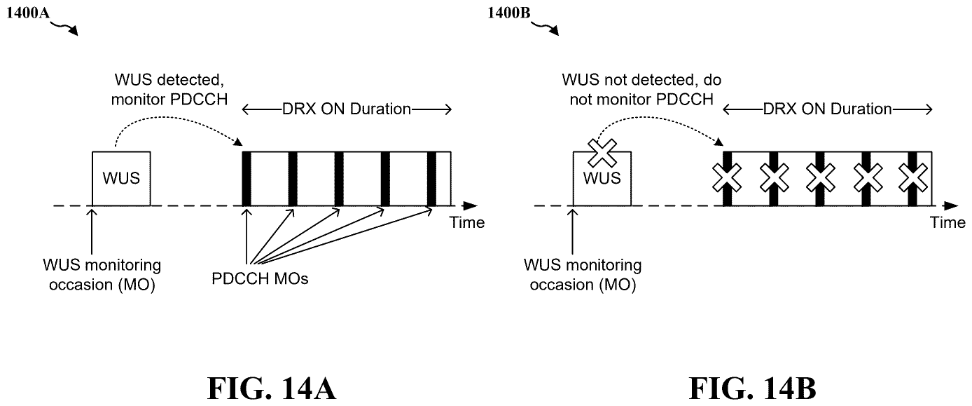

In some scenarios, a UE may be configured to monitor all DRX ON durations in its DRX pattern. In other scenarios, a WUS may be transmitted to a UE ahead of a DRX ON duration if the network is going to schedule the UE in that DRX ON duration. Thus, if the UE does not detect the WUS during the WUS monitoring occasion (MO), the UE may skip the upcoming PDCCH monitoring. For example, as shown by a diagram 1400A of FIG. 14A, when a UE detects a WUS during a WUS monitoring occasion, the UE may be configured to monitor all PDCCH occasions (which may be referred to as PDCCH monitoring occasions) within a corresponding DRX ON duration. On the other hand, as shown by a diagram 1400B of FIG. 14B, if a UE does not detect a WUS during a WUS monitoring occasion, the UE may skip all PDCCH monitoring occasions within the corresponding DRX ON duration. A PDCCH monitoring occasion may refer to one occasion or instance in which the UE monitors and receives PDCCH, such as shown at FIG. 14A. In some examples, such configuration/mechanism may provide up to ten (10) percent additional connected mode energy savings for infrequently scheduled devices, depending on the DRX settings.

Aspects presented herein may improve the positioning of a UE when the UE is under an idle/inactive mode. Aspects presented herein may enable a network entity (e.g., a base station, a location server, an LMF, etc.) to configure a UE to process positioning signals (e.g., to receive PRS, to transmit SRS, etc.) in a subset of a DRX ON duration, where the UE may be scheduled for both PRS and SRS with the same WUS/PDCCH signalling. Aspects presented herein may also enable the network entity to provide cross PFL scheduling of the PRS and SRS through a WUS of a serving cell, thereby improving the efficiency of the PRS/SRS scheduling in a UE positioning session.

In one aspect of the present disclosure, a network entity may schedule a UE to receive a set of PRSs (e.g., one or more PRSs) and/or to transmit a set of SRS (e.g., one or more SR Ss) during a subset (e.g., a portion) of a DRX ON duration after receiving a corresponding WUS associated with the DRX ON duration. As such, instead of monitoring for all PDCCH occasions in a DRX ON duration, a UE may monitor for just a subset of window inside the DRX ON duration to further improve power saving (e.g., during a UE positioning session while the UE is under an idle/inactive mode). In some examples, the network entity may signal the start and length of the subset of window inside the DRX ON duration (e.g., for receiving the set of PRS and/or for transmitting the SRS) to the UE through DCI formats. In other examples, the network entity may signal the start length of the subset of window through DCI formats, and the UE may calculate the corresponding length/duration for the subset of window based on one or more criteria, such as based on the expected RSTD and uncertainty associated with PRS/SRS resource sets, and/or TR P(s). In addition, the network entity may signal the scheduling of the PRS reception and/or SRS transmission inside the subset of window through the first PDCCH after the detected WUS, or through first N PDCCHs. Aspects presented herein may be useful for aperiodic (AP) and/or semi-persistent (SP) PRS/SRS scheduling, where activation/deactivation of PRS/SRS resources may be controlled by a network entity (e.g., a base station, a location server, an LMF, etc.).

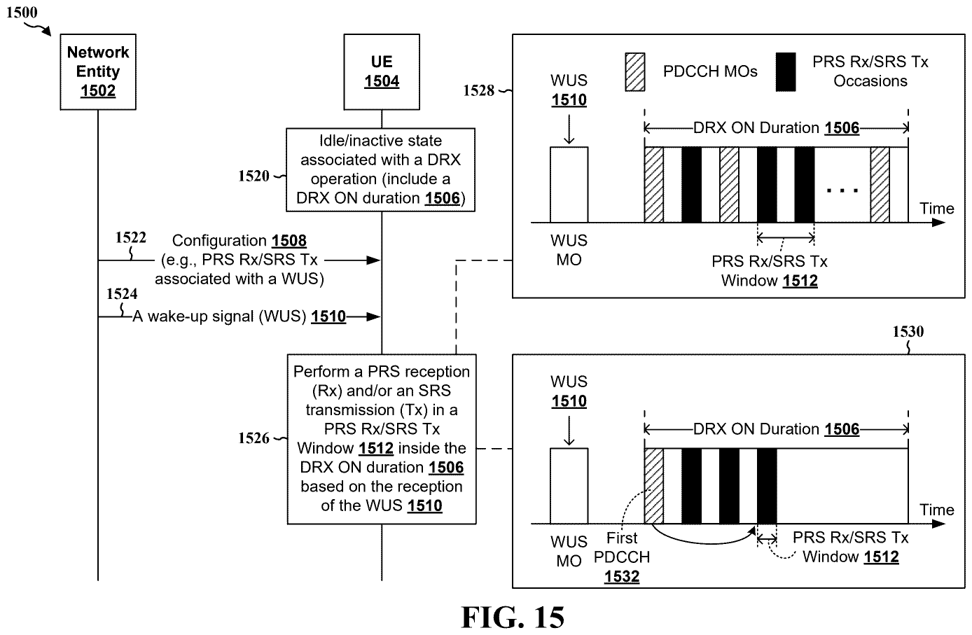

FIG. 15 is a communication flow 1500 illustrating an example of scheduling a UE to receive PRS(s) and/or to transmit SRS(s) during a subset (e.g., a portion) of a DRX ON duration after detecting a WUS in accordance with various aspects of the present disclosure. The numberings associated with the communication flow 1500 do not specify a particular temporal order and are merely used as references for the communication flow 1500.

At 1520, a UE 1504 may be in an RRC idle/inactive state with a network entity (e.g., a base station, a location server, an LMF, etc.), where the UE 1504 may be configured to perform a DRX operation, such as described in connection with FIGS. 6 and 7. The DRX operation may include multiple DRX cycles, where each DRX cycle may include a DRX ON duration 1506 and a DRX OFF duration, such as shown by FIG. 7.

At 1522, the UE 1504 may obtain a configuration 1508 associated with at least one of a PRS reception or an SRS transmission associated with a WUS. In some examples, the configuration 1508 may be pre-configured at the UE 1504. In other examples, the configuration 1508 may be generated by the network entity 1502 and transmitted to the UE 1504.

At 1524, the network entity 1502 may transmit a WUS 1510 to the UE 1504, where the WUS 1510 may indicate the UE 1504 to monitor for one or more PDCCH occasions (e.g., to perform one or more PDCCH MOs) inside the DRX ON duration 1506, such as described in connection with FIGS. 8, 10, 14A, and 14B.

At 1526, based on the WUS 1510, the UE 1504 may perform a PRS reception (Rx) and/or an SRS transmission (Tx) in a PRS Rx/SRS Tx window 1512 inside the DRX ON duration 1506 based on the reception of the WUS 1510 (and also based on the configuration 1508 which associates the WUS 1510 with the PRS reception and/or the SRS transmission). For example, as shown at 1528 and 1530, after the UE 1504 receives/detects the WUS 1510 during a WUS monitoring occasion, the UE 1504 may perform one or more PRS receptions (e.g., receive one or more PRSs) during a PRS reception window inside the DRX ON duration 1506 and/or perform one or more SRS transmissions (e.g., transmit one or more SRSs) during an SRS transmission window inside the DRX ON duration based on the reception of the WUS 1510. For purposes of the present disclosure, a PRS reception window may refer to a subset or a duration within the DRX ON duration 1506 in which the UE 1504 may use for receiving at least one PRS. The PRS reception window may be similar to the PRS Rx/SRS Tx Window 1512 but is dedicated for PRS reception. Similarly, an SRS transmission window may refer to a subset or a duration within the DRX ON duration 1506 in which the UE 1504 may use for transmitting at least one SRS. The SRS reception window may be similar to the PRS Rx/SRS Tx Window 1512 but is dedicated for SRS transmission.

In one example, as shown at 1528, the configuration 1508 may configure the UE 1504 to receive a subset of a set of PR Ss and/or to transmit a subset of a set of SRSs after the UE 1504 receives the WUS 1510 and wakes up. For example, there may be six PRS reception occasions or SRS transmission occasions during the DRX ON duration 1506 (e.g., configured based on an aperiodic and/or semi-persistent PRS/SRS scheduling). After the UE 1504 receives/detects the WUS 1510, the UE 1504 may be configured (e.g., by the configuration 1508) to just receive and measure the PRSs at the third and the fourth PRS reception occasions or to just transmit the SRSs at the third and the fourth SRS transmission occasions.

In one aspect of the present disclosure, the network entity 1502 may indicate a start time and a duration for the PRS Rx/SRS Tx window 1512, such as based on a DCI format associated with the WUS 1510 or associated with at least one PDCCH in the set of PDCCH MOs within the DRX ON duration 1506. For example, as shown at 1528, the network entity 1502 may indicate to the UE 1504 the start time and the duration for receiving and measuring the PRSs or for transmitting the SR Ss via a DCI format/message.

In another aspect of the present disclosure, the network entity 1502 may indicate just a start time for the PRS Rx/SRS Tx window 1512, such as based on a DCI format associated with the WUS 1510 or associated with at least one PDCCH in the set of PDCCH MOs within the DRX ON duration 1506. Then, the UE 1504 may calculate or determine the duration for the PRS Rx/SRS Tx window 1512, such as based on an RSTD or an uncertainty of a PRS resource set, an SRS resource set, or a TRP.

In another example, as shown at 1530, the scheduling of the PRS Rx/SRS Tx window 1512 may be signalled to the UE 1504 through the first PDCCH after the UE 1504 receives/detects the WUS 1510 or through the first N PDCCHs after the UE 1504 receives/detects the WUS 1510. For example, after the UE 1504 receives/detects the WUS 1510, the UE 1504 may monitor and receive a first PDCCH 1532 (or monitor and receive first N PDCCHs), where the first PDCCH 1532 may indicate the start time and the duration for the PRS Rx/SRS Tx window 1512. Similarly, the first PDCCH 1532 may also indicate just the start time for the PRS Rx/SRS Tx window 1512, and the UE 1504 may calculate or determine the duration for the PRS Rx/SRS Tx window 1512, such as based on an RSTD or an uncertainty of a PRS resource set, an SRS resource set, or a TRP. In another example, instead of indicating a star time and/or the duration for the PRS Rx/SRS Tx window 1512, the first PDCCH 1532 may also indicate a specific set of PRSs for the UE 1504 to receive/measure (e.g., the third PRS and the fourth PRS inside the DRX ON duration 1506) or a specific set of SR Ss for the UE 1504 to transmit (e.g., the third SRS and the fourth SRS inside the DRX ON duration 1506), etc.

In another aspect of the present disclosure, the network entity 1502 (e.g., a location server, an LMF, a base station, etc.) may activate the SRS transmission(s) and/or the PRS reception(s) at the UE 1504 based on the same WUS or different WUSs.

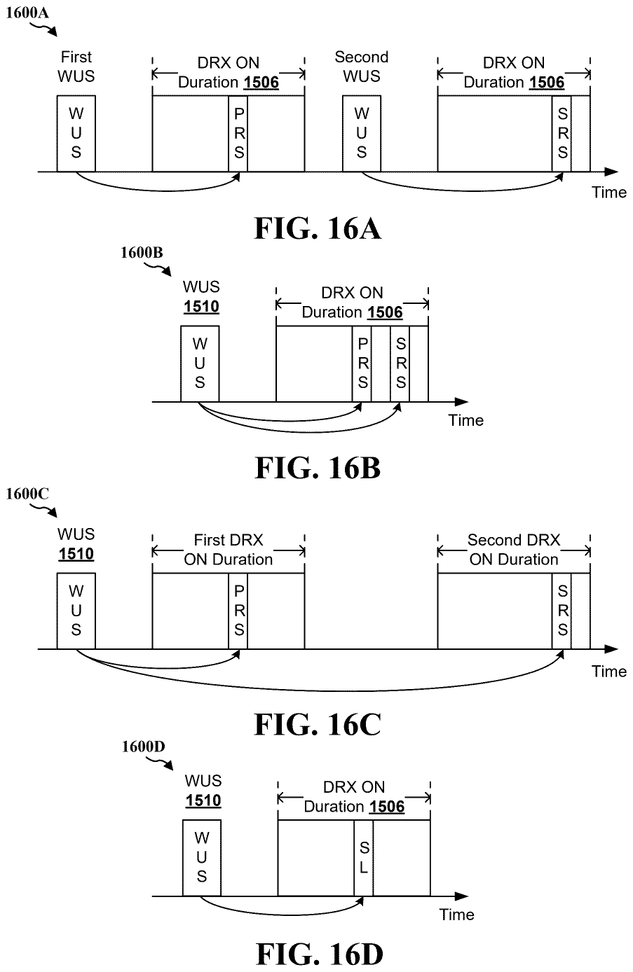

FIG. 16A is a diagram 1600A illustrating an example of a separate WUS based scheduling for PRS (reception) and SRS (transmission) in accordance with various aspects of the present disclosure. In one aspect, the UE 1504 may be configured to (e.g., by the network entity 1502 or pre-configured at the UE 1504) perform at least one PRS reception (e.g., during the PRS Rx/SRS Tx window 1512 or the corresponding PRS reception window/instance(s)) within the DRX ON duration 1506 if the UE 1504 receives a first WUS (or a first type of WUS format), and the UE 1504 may be configured to perform at least one SRS transmission (e.g., during the PRS Rx/SRS Tx window 1512 or the corresponding SRS transmission window/instance(s)) within the DRX ON duration 1506 if the UE 1504 receives a second WUS (or a second type of WUS format), etc.

FIG. 16B is a diagram 1600B illustrating an example of a same WUS based scheduling for PRS (reception) and SRS (transmission) in accordance with various aspects of the present disclosure. In another aspect, a same WUS may be used to schedule the PRS reception and SRS transmission on the same DRX ON duration. For example, the UE 1504 may be configured to (e.g., by the network entity 1502 or pre-configured at the UE 1504) perform at least one PRS reception and at least one SRS transmission during the PRS Rx/SRS Tx window 1512 or during their corresponding PRS reception/SRS transmission windows/instances within the DRX ON duration 1506 after the UE 1504 receives the WUS 1510.

FIG. 16C is a diagram 1600C illustrating an example of a same WUS based scheduling for PRS (reception) and SRS (transmission) on different DRX ON durations (or cycles) in accordance with various aspects of the present disclosure. In another aspect, a same WUS may be used to schedule the PRS reception and SRS transmission on different DRX ON durations/cycles. For example, after the UE 1504 receives the WUS 1510, the UE 1504 may be configured to (e.g., by the network entity 1502 or pre-configured at the UE 1504) perform at least one PRS reception (e.g., during the PRS Rx/SRS Tx window 1512 or the corresponding PRS reception window/instance(s)) within a first DRX ON duration/cycle, and the UE 1504 may also perform at least one SRS transmission (e.g., during the PRS Rx/SRS Tx window 1512 or the corresponding SRS transmission window/instance(s)) within a second DRX ON duration/cycle.

FIG. 16D is a diagram 1600D illustrating an example of a WUS based scheduling for sidelink (SL) transmission and/or reception in accordance with various aspects of the present disclosure. In another aspect, the WUS may be used to schedule SL transmission(s) and/or reception(s). For example, after the UE 1504 receives the WUS 1510, the UE 1504 may be configured to (e.g., by the network entity 1502 or pre-configured at the UE 1504) perform at least one SL reception (e.g., receiving at least one SRS from another UE via SL) or at least one SL transmission (e.g., transmitting at least one SRS to another UE via SL) during the PRS Rx/SRS Tx window 1512 or the corresponding SRS transmission reception window/instance(s) within the DRX ON duration 1506.

In another aspect of the present disclosure, at least one PRS reception and/or at least one SRS reception may be scheduled outside the DRX ON duration through WUS. For example, after the UE 1504 receives the WUS 1510, the UE 1504 may be configured to (e.g., by the network entity 1502 or pre-configured at the UE 1504) perform at least one PRS reception and/or at least one SRS transmission outside the DRX ON duration 1506.

In another aspect of the present disclosure, the network entity 1502 may be configured to provide sufficient details regarding the associations between the WUS and corresponding PRS reception(s) and/or SRS transmission(s) to the UE 1504 (e.g., as described in connection with FIGS. 16A to 16D), such as via the configuration 1508 or via a separate signalling. In addition, the network entity 1502 may also configure or indicate to the UE 1504 which PFL(s), TRP(s), PRS resource set(s), and/or PRS resource(s) is to be measured after a WUS (e.g., the WUS 1510) is detected/received, such as described in connection with FIG. 5. Similarly, the network entity 1502 may also configure or indicate to the UE 1504 which SRS resource set(s) and/or SRS resources are to be used for transmitting the SRS(s) after a WUS (e.g., the WUS 1510) is detected/received. The network entity 1502 may also provide PFL related information for PRS and BWP for the SRS to the UE 1504, such that the UE 1504 may have a more precise understanding regarding which resource(s) may be used for receiving PRS(s) and/or for transmitting SRS(s).

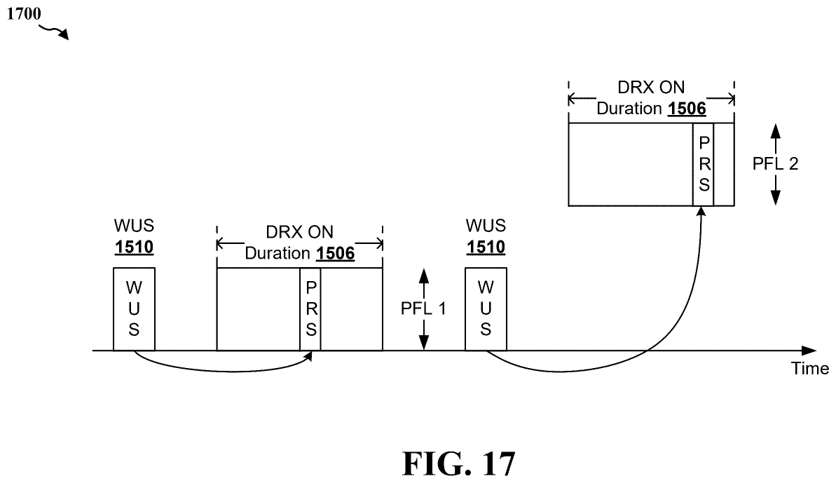

FIG. 17 is a diagram 1700 illustrating an example of a WUS based cross PFL scheduling in accordance with various aspects of the present disclosure. In one aspect, cross-carrier scheduling of data may be supported through the WUS, where up to five (5) SCell scheduling may be triggered through the WUS framework (e.g., after receiving a WUS). In another aspect, a cross-PFL scheduling of SRS and/or PRS signals may also be provided to (or configured for) the network entity 1502 and/or the UE 1504.

For example, after the UE 1504 receives the WUS 1510 within a first PFL, the UE 1504 may be configured to receive at least one PR S or transmit at least one SRS within the first PFL (and also within the DRX ON duration 1506), or the UE 1504 may be configured to receive at least one PRS or transmit at least one SRS in a second PFL. In other words, a WUS may trigger the UE 1504 to receive PRS(s) and/or to transmit SRS(s) at a PFL that is different from the PFL in which the WUS is received/detected. In some examples, there may be a maximum of four PFLs supported by the UE 1504. The network entity 1502 may indicate to the UE 1504 how many PFLs are to be used for the cross-PFL scheduling. For example, one or more bits in DCI (or in the DCI format) may be configured for the cross-PFL scheduling, where one bit may be specified for two (2) PFLs configuration or for the four (4) PFL configuration.

In another aspect of the present disclosure, the association between the WUS and corresponding PRS reception(s) and/or SRS transmission(s) framework described in connection with FIGS. 15 to 17 may also be used in association with RF fingerprinting (e.g., determining the position of a UE based on RF signals received/measured by the UE) and/or RF sensing (determining the position of an object based on RF signals reflected from the object). For example, when a UE (e.g., the UE 1504) is in the RRC inactive state, such as described in connection with FIG. 6, a network entity (e.g., the network entity 1502, a base station, a location server, an LMF, etc.) may command/trigger the UE to transmit SRS through WUS signal (e.g., by sending WUS signal to the UE). The SRS transmission may be configured to be aperiodic, and the UE may be configured to transmit SRS based on the request of the network entity. Similarly, the network entity may provide information to the UE regarding which SRS resource sets and/or SRS resources are to be used for transmitting the SRS(s) in response to receiving/detecting a WUS. Then, the network entity may perform measurements for the SRS(s) transmitted by the UE, and use the SRS measurements for the RF fingerprinting and/or for the RF sensing.

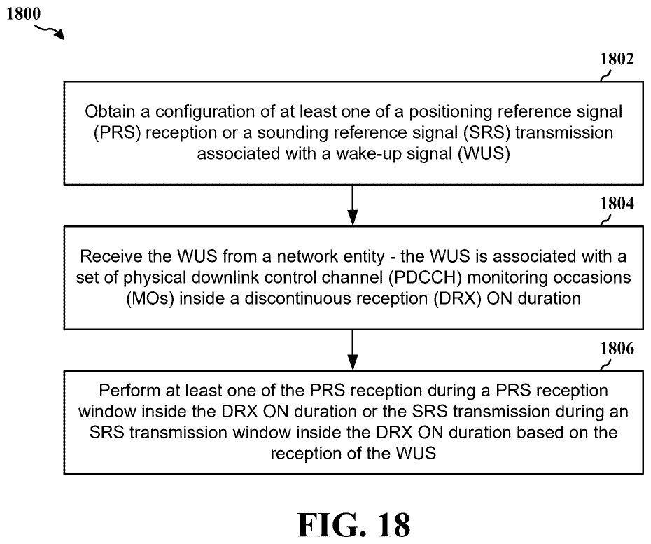

FIG. 18 is a flowchart 1800 of a method of wireless communication. The method may be performed by a UE (e.g., the UE 104, 404, 1504; the apparatus 1904). The method may enable the UE in an idle/inactive mode to process positioning signals (e.g., to receive PRS and/or to transmit SRS, etc.) in a subset of a DRX ON duration after receiving a WUS.

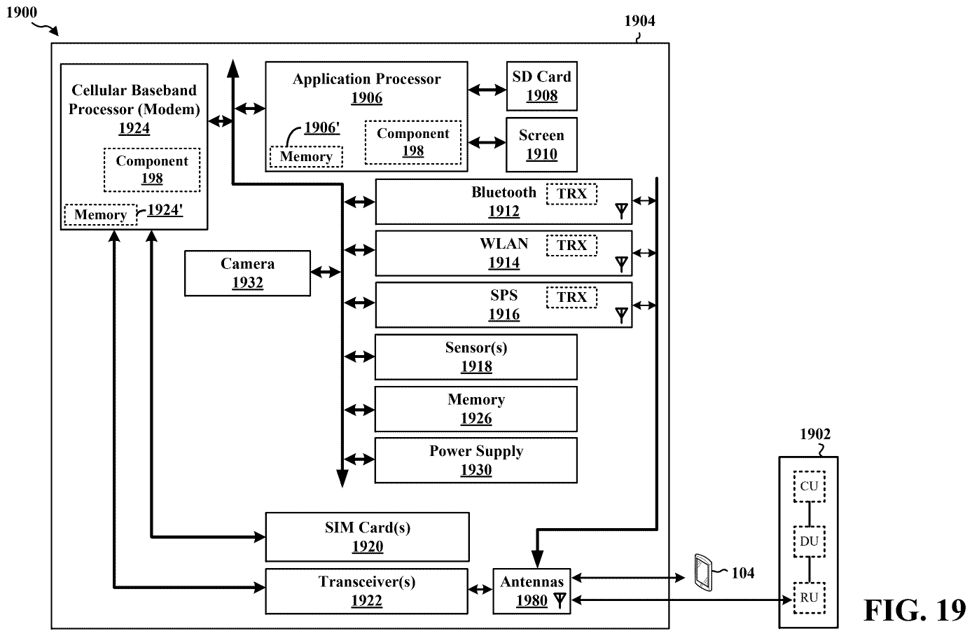

At 1802, the UE may obtain a configuration of at least one of a PRS reception or an SRS transmission associated with a WUS, such as described in connection with FIG. 15. For example, at 1522, the UE 1504 may obtain a configuration 1508 from the network entity 1502, where the configuration 1508 configures the UE 1504 to associate PRS reception and/or SRS transmission with a WUS. The obtaining of the configuration may be performed by, e.g., the WUS detection component 198, the cellular baseband processor 1924, and/or the transceiver(s) 1922 of the apparatus 1904 in FIG. 19.

At 1804, the UE may receive the WUS from a network entity, where the WUS is associated with a set of PDCCH MOs inside a DRX ON duration, such as described in connection with FIGS. 15 to 17. For example, as shown at 1524 and 1528 of FIG. 15, the UE 1504 may receive a WUS 1510 from the network entity 1502, where the WUS 1510 is associated with a set of PDCCH MOs inside the DRX ON duration 1506. The reception of the WUS may be performed by, e.g., the WUS detection component 198, the cellular baseband processor 1924, and/or the transceiver(s) 1922 of the apparatus 1904 in FIG. 19.

At 1806, the UE may perform at least one of the PRS reception during a PRS reception window inside the DRX ON duration or the SRS transmission during an SRS transmission window inside the DRX ON duration based on the reception of the WUS, such as described in connection with FIGS. 15 to 17. For example, at 1526 of FIG. 15, the UE 1504 may perform a PRS reception and/or an SRS transmission in a PRS Rx/SRS Tx Window 1512 inside the DRX ON duration 1506 based on the reception of the WUS 1510. The PRS reception during the PRS reception window and/or the SRS transmission during the SRS transmission window may be performed by, e.g., the WUS detection component 198, the cellular baseband processor 1924, and/or the transceiver(s) 1922 of the apparatus 1904 in FIG. 19.

In one example, the UE may detect a start time and a duration for at least one of the PRS reception window or the SRS transmission window based on a DCI format associated with the WUS or associated with at least one PDCCH in the set of PDCCH MOs.

In another example, the UE may detect a start time for at least one of the PRS reception window or the SRS transmission window based on a DCI format associated with the WUS or associated with at least one PDCCH in the set of PDCCH MOs; and the UE may calculate a duration for the PRS reception window or the SRS transmission window based on an expected RSTD or an uncertainty of a PR S resource set, an SRS resource set, or a TRP.

In another example, the UE may receive a first PDDCH or first N PDDCHs in the set of PDCCH MOs after the reception of the WUS, and the UE may detect a start time and a duration for at least one of the PRS reception window or the SRS transmission window based the first PDCCH or the first N PDCCHs.

In another example, the UE may receive scheduling for at least one of the PRS reception window or the SRS transmission window. In such an example, the scheduling is received outside of the DRX ON duration. In such an example, the scheduling is received prior to the reception of the WUS.

In another example, the PRS reception during the PRS reception window and the SRS transmission during the SRS transmission window are associated with different WUSs.

In another example, the PRS reception during the PRS reception window and the SRS transmission during the SRS transmission window is associated with a same WUS. In such an example, the PRS reception window and the SRS transmission window are scheduled within a same DRX cycle or within different DRX cycles.

In another example, at least one of the PRS reception or the SRS transmission is associated with SL communication.

In another example, the UE may receive an indication from the network entity indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

In another example, the WUS is received on a first PFL and at least one of the PRS transmission or the SRS reception is on a second PFL based on a cross PFL scheduling. In such an example, the UE may receive an indication of a number of PFLs associated with the cross PFL scheduling.

In another example, each of the PRS reception window and the SRS transmission window is shorter than the DRX ON duration.

In another example, the network entity is a base station, a component of the base station, a location server, or LMF.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the WUS detection component 198 is configured to obtain a configuration of at least one of a PRS reception or an SRS transmission associated with a WUS. The WUS detection component 198 may also be configured to receive the WUS from a network entity, where the WUS is associated with a set of PDCCH MOs inside a DRX ON duration. The WUS detection component 198 may also be configured to perform at least one of the PRS reception during a PRS reception window inside the DRX ON duration or the SRS transmission during an SRS transmission window inside the DRX ON duration based on the reception of the WUS. The WUS detection component 198 may be within the cellular baseband processor 1924, the application processor 1906, or both the cellular baseband processor 1924 and the application processor 1906. The WUS detection component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for obtaining a configuration of at least one of a PRS reception or an SRS transmission associated with a WUS. The apparatus 1904 may further include means for receiving the WUS from a network entity, where the WUS is associated with a set of PDCCH MOs inside a DRX ON duration. The apparatus 1904 may further include means for performing at least one of the PRS reception during a PRS reception window inside the DRX ON duration or the SRS transmission during an SRS transmission window inside the DRX ON duration based on the reception of the WUS.

In one example, the apparatus 1904 may further include means for detecting a start time and a duration for at least one of the PRS reception window or the SRS transmission window based on a DCI format associated with the WUS or associated with at least one PDCCH in the set of PDCCH MOS.

In another example, the apparatus 1904 may further include means for detecting a start time for at least one of the PRS reception window or the SRS transmission window based on a DCI format associated with the WUS or associated with at least one PDCCH in the set of PDCCH MOs; and the UE may calculate a duration for the PRS reception window or the SRS transmission window based on an expected RSTD or an uncertainty of a PRS resource set, an SRS resource set, or a TRP.

In another example, the apparatus 1904 may further include means for receiving a first PDDCH or first N PDDCHs in the set of PDCCH MOs after the reception of the WUS, and means for detecting a start time and a duration for at least one of the PRS reception window or the SRS transmission window based the first PDCCH or the first N PDCCHs.

In another example, the apparatus 1904 may further include means for receiving scheduling for at least one of the PRS reception window or the SRS transmission window. In such an example, the scheduling is received outside of the DRX ON duration. In such an example, the scheduling is received prior to the reception of the WUS.

In another example, the PRS reception during the PRS reception window and the SRS transmission during the SRS transmission window are associated with different WUSS.

In another example, the PRS reception during the PRS reception window and the SRS transmission during the SRS transmission window is associated with a same WUS. In such an example, the PRS reception window and the SRS transmission window are scheduled within a same DRX cycle or within different DRX cycles.

In another example, at least one of the PRS reception or the SRS transmission is associated with SL communication.

In another example, the apparatus 1904 may further include means for receiving an indication from the network entity indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

In another example, the WUS is received on a first PFL and at least one of the PRS transmission or the SRS reception is on a second PFL based on a cross PFL scheduling. In such an example, the apparatus 1904 may further include means for receiving an indication of a number of PFLs associated with the cross PFL scheduling.

In another example, each of the PRS reception window and the SRS transmission window is shorter than the DRX ON duration.

In another example, the network entity is a base station, a component of the base station, a location server, or LMF.

The means may be the WUS detection component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

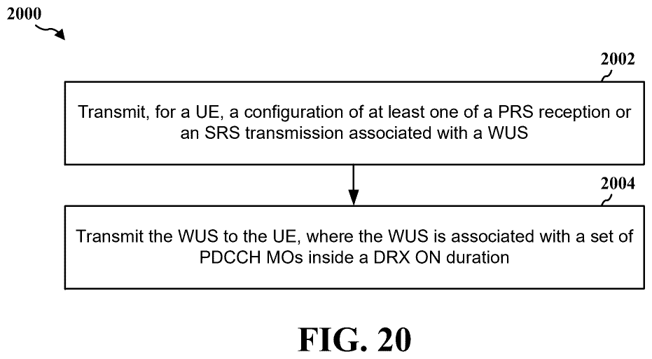

FIG. 20 is a flowchart 2000 of a method of wireless communication. The method may be performed by a base station (e.g., the base station 102; the network entity 1502, 2102. The method may enable the base station to configure a UE in an idle/inactive mode to process positioning signals (e.g., to receive PRS and/or to transmit SRS, etc.) in a subset of a DRX ON duration after the UE receives a WUS.

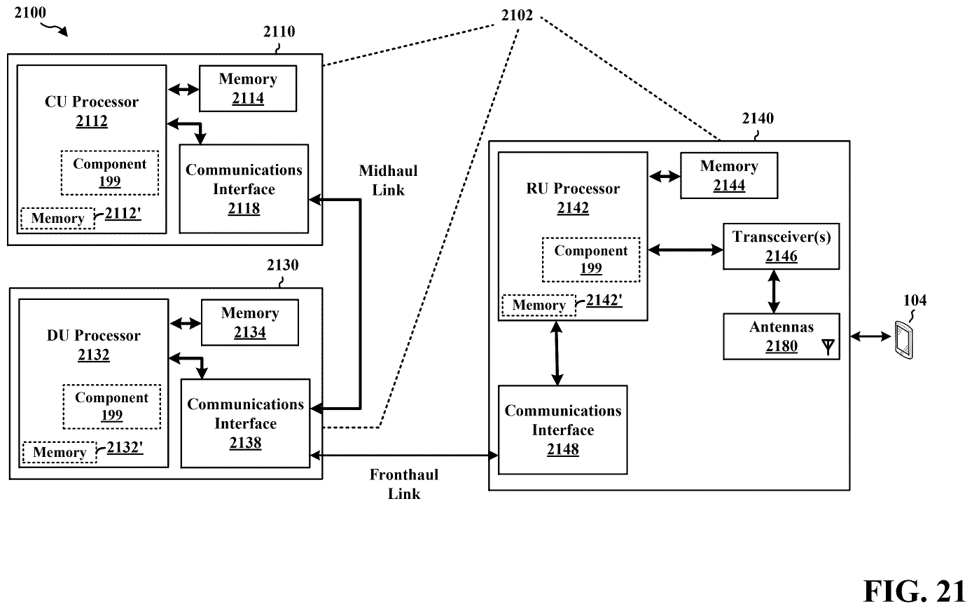

At 2002, the base station may transmit, for a UE, a configuration of at least one of a PRS reception or an SRS transmission associated with a WUS, such as described in connection with FIG. 15. For example, at 1522, the network entity 1502 may transmit a configuration 1508 to the UE 1504, where the configuration 1508 configures at least one of a PRS reception or an SRS transmission associated with a WUS at the UE 1504. The transmission of the configuration may be performed by, e.g., the WUS and PRS/SRS association configuration component 199 and/or the transceiver(s) 2146 of the network entity 2102 in FIG. 21.

At 2004, the base station may transmit the WUS to the UE, where the WUS is associated with a set of PDCCH MOs inside a DRX ON duration, such as described in connection with FIG. 15. For example, at 1524 and 1528, the network entity 1502 may transmit a WUS 1510 to the UE 1504, where the WUS 1510 is associated with a set of PDCCH MOs inside a DRX ON duration 1506. The transmission of the WUS may be performed by, e.g., the WUS and PRS/SRS association configuration component 199 and/or the transceiver(s) 2146 of the network entity 2102 in FIG. 21.

In one example, the base station may indicate to the UE at least one of a start time or a duration for at least one of a PRS reception window for the PRS reception or an SRS transmission window for the SRS transmission based on a DCI format associated with the WUS or associated with at least one PDCCH in the set of PDCCH MOS.

In another example, the base station may indicate to the UE at least one of a start time or a duration for at least one of a PRS reception window for the PRS reception or an SRS transmission window for the SRS transmission via a first PDCCH or first N PDCCHs in the set of PDCCH MOS.

In another example, the base station may transmit, for the UE, scheduling for at least one of a PRS reception window for the PRS reception or an SRS transmission window for the SRS transmission. In such an example, the scheduling is transmitted outside of the DRX ON duration. In such an example, the scheduling is transmitted prior to the transmission of the WUS.

In another example, the PRS reception during a PRS reception window and the SRS transmission during an SRS transmission window are associated with different W U Ss. In another example, the PRS reception during a PRS reception window and the SRS [0181] transmission during an SRS transmission window is associated with a same WUS. In such an example, the PRS reception window and the SRS transmission window are scheduled within a same DRX cycle or within different DRX cycles.

In another example, at least one of the PRS reception or the SRS transmission is associated with SL communication.

In another example, the base station may transmit an indication for the UE indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

In another example, the transmission of the WUS and at least one of the PRS transmission or the SRS reception are scheduled on different PFLs based on a cross PFL scheduling. In such an example, the base station may transmit, for the UE, an indication of a number of PFLs associated with the cross PFL scheduling.

In another example, the network entity is a base station, a component of the base station, a location server, or LMF.

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the WUS and PRS/SRS association configuration component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the WUS and PRS/SRS association configuration component 199 is configured to transmit, for a UE, a configuration of at least one of a PRS reception or an SRS transmission associated with a WUS. The WUS and PRS/SRS association configuration component 199 may also be configured to transmit the WUS to the UE, where the WUS is associated with a set of PDCCH MOs inside a DRX ON duration. The WUS and PRS/SRS association configuration component 199 may be within one or more processors of one or more of the CU 2110, DU 2130, and the RU 2140. The WUS and PRS/SRS association configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for transmitting, for a UE, a configuration of at least one of a PRS reception or an SRS transmission associated with a WUS. The network entity 2102 may further include means for transmitting the WUS to the UE, where the WUS is associated with a set of PDCCH MOs inside a DRX ON duration.

In one example, the network entity 2102 includes means for indicating to the UE at least one of a start time or a duration for at least one of a PRS reception window for the PRS reception or an SRS transmission window for the SRS transmission based on a DCI format associated with the WUS or associated with at least one PDCCH in the set of PDCCH MOS.

In another example, the network entity 2102 includes means for indicating to the UE at least one of a start time or a duration for at least one of a PRS reception window for the PRS reception or an SRS transmission window for the SRS transmission via a first PDCCH or first N PDCCHs in the set of PDCCH MOS.

In another example, the network entity 2102 includes means for transmitting, for the UE, scheduling for at least one of a PRS reception window for the PRS reception or an SRS transmission window for the SRS transmission. In such an example, the scheduling is transmitted outside of the DRX ON duration. In such an example, the scheduling is transmitted prior to the transmission of the WUS.

In another example, the PRS reception during a PRS reception window and the SRS transmission during an SRS transmission window are associated with different W U Ss.

In another example, the PRS reception during a PRS reception window and the SRS transmission during an SRS transmission window is associated with a same WUS. In such an example, the PRS reception window and the SRS transmission window are scheduled within a same DRX cycle or within different DRX cycles.

In another example, at least one of the PRS reception or the SRS transmission is associated with SL communication.

In another example, the network entity 2102 includes means for transmitting an indication for the UE indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

In another example, the transmission of the WUS and at least one of the PRS transmission or the SRS reception are scheduled on different PFLs based on a cross PFL scheduling. In such an example, the base station may transmit, for the UE, an indication of a number of PFLs associated with the cross PFL scheduling.

In another example, the network entity is a base station, a component of the base station, a location server, or LMF.

The means may be the WUS and PRS/SRS association configuration component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: obtaining a configuration of at least one of a PRS reception or an SRS transmission associated with a WUS; receiving the WUS from a network entity, where the WUS is associated with a set of PDCCH MOs inside a DRX ON duration; and performing at least one of the PRS reception during a PRS reception window inside the DRX ON duration or the SRS transmission during an SRS transmission window inside the DRX ON duration based on the reception of the WUS.

Aspect 2 is the method of aspect 1, further including: detecting a start time and a duration for at least one of the PRS reception window or the SRS transmission window based on a DCI format associated with the WUS or associated with at least one PDCCH in the set of PDCCH MOS.

Aspect 3 is the method of aspect 1 or 2, further including: detecting a start time for at least one of the PRS reception window or the SRS transmission window based on a DCI format associated with the WUS or associated with at least one PDCCH in the set of PDCCH MOs; and calculating a duration for the PRS reception window or the SRS transmission window based on an expected RSTD or an uncertainty of a PRS resource set, an SRS resource set, or a TRP.

Aspect 4 is the method of any of aspects 1 to 3, further including: receiving a first PDDCH or first N PDDCHs in the set of PDCCH MOs after the reception of the WUS; and detecting a start time and a duration for at least one of the PRS reception window or the SRS transmission window based the first PDCCH or the first N PDCCHs.

Aspect 5 is the method of any of aspects 1 to 4, further including: receiving scheduling for at least one of the PRS reception window or the SRS transmission window.

Aspect 6 is the method of aspect 5, where the scheduling is received outside of the DRX ON duration.

Aspect 7 is the method of aspect 5, where the scheduling is received prior to the reception of the WUS.

Aspect 8 is the method of any of aspects 1 to 7, where the PRS reception during the PRS reception window and the SRS transmission during the SRS transmission window are associated with different WUSs.

Aspect 9 is the method of any of aspects 1 to 8, where the PRS reception during the PRS reception window and the SRS transmission during the SRS transmission window is associated with a same WUS.

Aspect 10 is the method of aspect 9, where the PRS reception window and the SRS transmission window are scheduled within a same DRX cycle or within different DRX cycles.

Aspect 11 is the method of any of aspects 1 to 10, where at least one of the PRS reception or the SRS transmission is associated with SL communication.

Aspect 12 is the method of any of aspects 1 to 11, further including receiving an indication from the network entity indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

Aspect 13 is the method of any of aspects 1 to 12, where the WUS is received on a first PFL and at least one of the PRS transmission or the SRS reception is on a second PFL based on a cross PFL scheduling.

Aspect 14 is the method of aspect 13, further including: receiving an indication of a number of PFLs associated with the cross PFL scheduling.

Aspect 15 is the method of any of aspects 1 to 14, where each of the PRS reception window and the SRS transmission window is shorter than the DRX ON duration.

Aspect 16 is the method of any of aspects 1 to 15, where the network entity is a base station, a component of the base station, a location server, or LMF.

Aspect 17 is an apparatus for wireless communication at a UE, including: a memory; and at least one processor coupled to the memory and, based at least in part on information stored in the memory, the at least one processor is configured to implement any of aspects 1 to 16.

Aspect 18 is the apparatus of aspect 17, further including at least one of a transceiver or an antenna coupled to the at least one processor.

Aspect 19 is an apparatus for wireless communication including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

Aspect 21 is a method of wireless communication at a network entity, including: transmitting, for a UE, a configuration of at least one of a PRS reception or an SRS transmission associated with a WUS; and transmitting the WUS to the UE, where the WUS is associated with a set of PDCCH MOs inside a DRX ON duration.

Aspect 22 is the method of aspect 21, further including: indicating to the UE at least one of a start time or a duration for at least one of a PRS reception window for the PRS reception or an SRS transmission window for the SRS transmission based on a DCI format associated with the WUS or associated with at least one PDCCH in the set of PDCCH MOS.

Aspect 23 is the method of aspect 21 or aspect 22, further including: indicating to the UE at least one of a start time or a duration for at least one of a PRS reception window for the PRS reception or an SRS transmission window for the SRS transmission via a first PDCCH or first N PDCCHs in the set of PDCCH MOS.

Aspect 24 is the method of any of aspects 21 to 23, further including: transmitting, for the UE, scheduling for at least one of a PRS reception window for the PRS reception or an SRS transmission window for the SRS transmission.

Aspect 25 is the method of aspect 24, where the scheduling is transmitted outside of the DRX ON duration.

Aspect 26 is the method of aspect 24, where the scheduling is transmitted prior to the transmission of the WUS.

Aspect 27 is the method of any of aspects 21 to 26, where the PRS reception during a PRS reception window and the SRS transmission during an SRS transmission window are associated with different WUSs.

Aspect 28 is the method of any of aspects 21 to 27, where the PRS reception during a PRS reception window and the SRS transmission during an SRS transmission window is associated with a same WUS.

Aspect 29 is the method of aspect 28, where the PRS reception window and the SRS transmission window are scheduled within a same DRX cycle or within different DRX cycles.

Aspect 30 is the method of any of aspects 21 to 29, where at least one of the PRS reception or the SRS transmission is associated with SL communication.

Aspect 31 is the method of any of aspects 21 to 30, further including transmitting an indication for the UE indicating at least one of: at least one PRS TRP to be measured, at least one PRS resource set to be measured, at least one PRS resource to be measured, at least one SRS resource set to be used for the SRS transmission, at least one SRS resource to be used for the SRS transmission, PFL information associated with the PRS reception, BWP information associated with the SRS transmission, or a combination thereof.

Aspect 32 is the method of any of aspects 21 to 31, where the transmission of the WUS and at least one of the PRS transmission or the SRS reception are scheduled on different PFLs based on a cross PFL scheduling.

Aspect 33 is the method of aspect 32, further including: transmitting, for the UE, an indication of a number of PFLs associated with the cross PFL scheduling.

Aspect 34 is the method of any of aspects 21 to 33, where the network entity is a base station, a component of the base station, a location server, or LMF.

Aspect 35 is an apparatus for wireless communication at a network entity, including: a memory; and at least one processor coupled to the memory and, based at least in part on information stored in the memory, the at least one processor is configured to implement any of aspects 21 to 34.

Aspect 36 is the apparatus of aspect 35, further including at least one of a transceiver or an antenna coupled to the at least one processor.

Aspect 37 is an apparatus for wireless communication including means for implementing any of aspects 21 to 34.

Aspect 38 is a computer-readable medium (e.g., a non-transitory computer-readable medium) storing computer executable code, where the code when executed by a processor causes the processor to implement any of aspects 21 to 34.

1. An apparatus for wireless communication at a user equipment (UE), comprising:
a memory; and
at least one processor coupled to the memory and, based at least in part on information stored in the memory, the at least one processor is configured to:
obtain a configuration of at least one of a positioning reference signal (PRS) reception or a sounding reference signal (SRS) transmission associated with a wake-up signal (WUS);
receive the WUS from a network entity, wherein the WUS is associated with a set of physical downlink control channel (PDCCH) monitoring occasions (MOs) inside a discontinuous reception (DRX) ON duration; and perform at least one of the PRS reception during a PRS reception window inside the DRX ON duration or the SRS transmission during an SRS transmission window inside the DRX ON duration based on the reception of the WUS.

2. The apparatus of claim 1, wherein the at least one processor is further configured to:
detect a start time and a duration for at least one of the PRS reception window or the SRS transmission window based on a downlink control information (DCI) format associated with the WUS or associated with at least one PDCCH in the set of PDCCH MOs.

3. The apparatus of claim 1, wherein the at least one processor is further configured to:
detect a start time for at least one of the PRS reception window or the SRS transmission window based on a downlink control information (DCI) format associated with the WUS or associated with at least one PDCCH in the set of PDCCH MOs; and calculate a duration for the PRS reception window or the SRS transmission window based on an expected reference signal time difference (RSTD) or an uncertainty of a PRS resource set, an SRS resource set, or a transmission reception point (TRP).

4. The apparatus of claim 1, wherein the at least one processor is further configured to:
receive a first PDDCH or first N PDDCHs in the set of PDCCH MOs after the at least one processor is configured to receive the WUS; and
detect a start time and a duration for at least one of the PRS reception window or the SRS transmission window based the first PDCCH or the first N PDCCHs.

5. The apparatus of claim 1, wherein the at least one processor is further configured to:
receive scheduling for at least one of the PRS reception window or the SRS transmission window.

6. The apparatus of claim 5, wherein the at least one processor is configured to receive the scheduling outside of the DRX ON duration.

7. The apparatus of claim 5, wherein the at least one processor is configured to receive the scheduling prior to the at least one processor being configured to receive the WUS.

8. The apparatus of claim 1, wherein the PRS reception during the PRS reception window and the SRS transmission during the SRS transmission window are associated with different WUSs.

9. The apparatus of claim 1, wherein the PRS reception during the PRS reception window and the SRS transmission during the SRS transmission window is associated with a same WUS.

10. The apparatus of claim 9, wherein the PRS reception window and the SRS transmission window are configured to be scheduled within a same DRX cycle or within different DRX cycles.

11. (canceled)

12. The apparatus of claim 1, wherein the at least one processor is further configured to receive an indication from the network entity indicating at least one of:
at least one PRS transmission reception point (TRP) configured to be measured, at least one PRS resource set configured to be measured,
at least one PRS resource configured to be measured,
at least one SRS resource set configured to be used for the SRS transmission, at least one SRS resource configured to be used for the SRS transmission, positioning frequency layer (PFL) information associated with the PRS reception, bandwidth part (BWP) information associated with the SRS transmission, or a combination thereof.

13. The apparatus of claim 1, wherein the at least one processor is configured to receive the WUS on a first positioning frequency layer (PFL) and at least one of the PRS transmission or the SRS reception is on a second PFL based on a cross PFL scheduling.

14. (canceled)

15. (canceled)

16. (canceled)

17. (canceled)

18. An apparatus for wireless communication at a network entity, comprising:
a memory; and
at least one processor coupled to the memory and, based at least in part on information stored in the memory, the at least one processor is configured to:
transmit, for a user equipment (UE), a configuration of at least one of a positioning reference signal (PRS) reception or a sounding reference signal (SRS) transmission associated with a wake-up signal (WUS); and transmit the WUS to the UE, wherein the WUS is associated with a set of physical downlink control channel (PDCCH) monitoring occasions (MOs) inside a discontinuous reception (DRX) ON duration.

19. The apparatus of claim 18, wherein the at least one processor is further configured to:
indicate to the UE at least one of a start time or a duration for at least one of a PRS reception window for the PRS reception or an SRS transmission window for the SRS transmission based on a downlink control information (DCI) format associated with the WUS or associated with at least one PDCCH in the set of PDCCH MOs.

20. The apparatus of claim 18, wherein the at least one processor is further configured to:
indicate to the UE at least one of a start time or a duration for at least one of a PRS reception window for the PRS reception or an SRS transmission window for the SRS transmission via a first PDCCH or first N PDCCHs in the set of PDCCH MOs.

21. (canceled)

22. (canceled)

23. (canceled)

24. The apparatus of claim 18, wherein the PRS reception during a PRS reception window and the SRS transmission during an SRS transmission window are associated with different WUSs.

25. The apparatus of claim 18, wherein the PRS reception during a PRS reception window and the SRS transmission during an SRS transmission window is associated with a same WUS.

26. (canceled)

27. The apparatus of claim 18, wherein the at least one processor is further configured to transmit an indication for the UE indicating at least one of:
at least one PRS transmission reception point (TRP) configured to be measured, at least one PRS resource set configured to be measured,
at least one PRS resource configured to be measured,
at least one SRS resource set configured to be used for the SRS transmission, at least one SRS resource configured to be used for the SRS transmission, positioning frequency layer (PFL) information associated with the PRS reception, bandwidth part (BWP) information associated with the SRS transmission, or a combination thereof.

28. The apparatus of claim 18, wherein the transmission of the WUS and at least one of the PRS transmission or the SRS reception are configured to be scheduled on different positioning frequency layers (PFLs) based on a cross PFL scheduling.

29. (canceled)

30. A method of wireless communication at a network entity, comprising:
transmitting, for a user equipment (UE), a configuration of at least one of a positioning reference signal (PRS) reception or a sounding reference signal (SRS) transmission associated with a wake-up signal (WUS); and
transmitting the WUS to the UE, wherein the WUS is associated with a set of physical downlink control channel (PDCCH) monitoring occasions (MOs) inside a discontinuous reception (DRX) ON duration.
